(19) United States
(12) Patent Application Publication
(10) Pub. No.: US 2009/0301424 A1
(43) Pub. Date: Dec. 10, 2009

(54) STARTER PULL CORDS FOR INTERNAL COMBUSTION ENGINES

(75) Inventor: Paul Abell, Langley (CA)

Correspondence Address: NEXUS LAW GROUP LLP, 1500 - 701 WEST GEORGIA STREET, VANCOUVER, BC, V7Y 1C6, CA

(73) Assignee: 0813446 B.C. LTD., Surrey, BC (CA)

(21) Appl. No.: 12/524,156

(22) PCT Filed: Jan. 23, 2008
(86) PCT No.: PCT/CA08/00116

§ 371 Date: Jul. 22, 2009

Related U.S. Application Data
(60) Provisional application No. 60/886,117, filed on Jan. 23, 2007.

(30) Foreign Application Priority Data
Mar. 26, 2007 (US) 11690889
Aug. 2, 2007 (CA) 2,596014

(51) Int. Cl. F02N 3/02; D07B 1/02

(52) U.S. Cl. 123/185.2; 87/8

(57) ABSTRACT

An improved starter pull cord for an internal combustion engine having significantly increased stiffness, resistance to wear, and strength, the starter pull cord being comprised of rope having high modulus fibers selected from the group consisting of liquid crystal polymer (LCP), aramid, and high-modulus polyethylene (HMPE). The higher stiffness of the high modulus starter pull cords of the present invention translates to greater impetus during the act of pull starting the engine, which is apt to start more quickly than with starter pull cords of the prior art. The increased strength of the high modulus starter pull cords translates to fewer breakages over the lifetime of an engine and therefore increased reliability.

### FIELD OF THE INVENTION

The present invention relates to improved starter pull cords that are commonly used on gasoline engines.

### BACKGROUND OF THE INVENTION

Gasoline powered engines are used to power numerous kinds of tools (i.e. weed cutters, lawn mowers, snow blowers, pumps, generators, garden tillers, etc.), snowmobiles, outboard boat motors, motorcycles and all-terrain vehicles. Many of these engines have a manual starter mechanism employing a pull cord having an attached handle to provide the initial impetus to start the engine. The pull cord is wound around a starter pulley that is connected to the engine's crankshaft. To start the engine, a user pulls on the starter cord to unwind it from the pulley thereby imparting a rotational movement to the crankshaft, which provides the impetus to start the engine. Frequently, the starter reel is confined within a starter housing that is dimension to fit closely around the wheel to prevent the pull cord from unraveling from the reel. Motor starter pull cords are typically made from nylon fiber. One problem with these nylon pull starter cords of the prior art is that they sometimes do not provide enough impetus to start the engine on the first pull or even on subsequent tries. Another problem with these starter cords of the prior art is that they wear out and break more frequently than desired—usually at the most inopportune moments—rendering the engine, and hence the device that relies on the engine, inoperable. In some applications, for example, outboard boat motors, motorcycles, all-terrain vehicles and snowmobiles, the inability to quickly start the engine at an inopportune time could be downright disastrous. Accordingly, it would be desirable to have a starter pull cord that provides greater impetus and thus is more apt to start the engine on the first pull than the starter pull cords of the prior art. It would also be desirable to have a starter pull cord that is significantly stronger and resistant to wear and breakage than the starter pull cords of the prior art.

### SUMMARY OF THE INVENTION

The above shortcomings may be addressed by providing, in accordance with one aspect of the invention, a starter pull cord for an internal combustion engine comprised of rope made from fibers of the class high-modulus. Modulus is a measurement of stiffness, thus high-modulus fibers have much higher stiffness in tension than conventional fibers. High-modulus fibers are also significantly stronger than conventional fibers. This class includes the following fibers: liquid crystal polymer (LCP), aramid, and high-modulus polyethylene (HMPE). The higher stiffness of the high modulus starter pull cords of the present invention translates to greater impetus during the act of pull starting the engine, which is apt to start more quickly than with starter pull cords of the prior art. The increased strength of the high modulus starter pull cords translates to fewer breakages over the lifetime of an engine and therefore increased reliability.

In some aspects, the present invention provides a starter pull cord for an internal combustion engine comprised of rope having high modulus fibers selected from the group consisting of liquid crystal polymer (LCP), aramid, and high-modulus polyethylene (HMPE). In some embodiments, the rope consists of such high modulus fibers. In some embodiments, the rope is a single braided, multi-strand rope braided from the high modulus fibers. A handle may be connected to one end of said rope.

In another aspect, the present invention provides a method of starting an internal combustion engine that is adapted to being manually started by the act of pulling on a pull cord wrapped around a pulley, the method comprising the steps of wrapping a rope comprising high modulus fibers selected from the group consisting of liquid crystal polymer (LCP), aramid, and high-modulus polyethylene (HMPE) around the pulley, leaving a free end of the rope, and pulling on the free end rapidly to impart rotation to the pulley.

In another aspect, the present invention provides for the use of a rope comprising high modulus fibers selected from the group consisting of liquid crystal polymer (LCP), aramid, and high-modulus polyethylene (HMPE) as a starter pull cord for an internal combustion engine. In some embodiments, the rope consists of said high modulus fibers. In some embodiments, the rope is a single braided, multi-strand rope braided from the high modulus fibers.

In yet another aspect, the present invention provides a kit for replacing a starter pull cord for an internal combustion engine comprising: a rope having high modulus fibers selected from the group consisting of liquid crystal polymer (LCP), aramid, and high-modulus polyethylene (HMPE); a handle adapted to being connected to one end of said rope; and instructions that direct a user on how to effect the replacement of the starter pull cord. In some embodiments, the rope consists of said high modulus fibers. In some embodiments, the rope is a single braided, multi-strand rope braided from the high modulus fibers.

These and other aspects, features and embodiments are set forth within this application, including the following Detailed Description and attached drawing. The present invention comprises a variety of aspects, features and embodiments; such multiple aspects, features and embodiments can be combined and permuted in any desired manner.

### BRIEF DESCRIPTION OF THE DRAWINGS

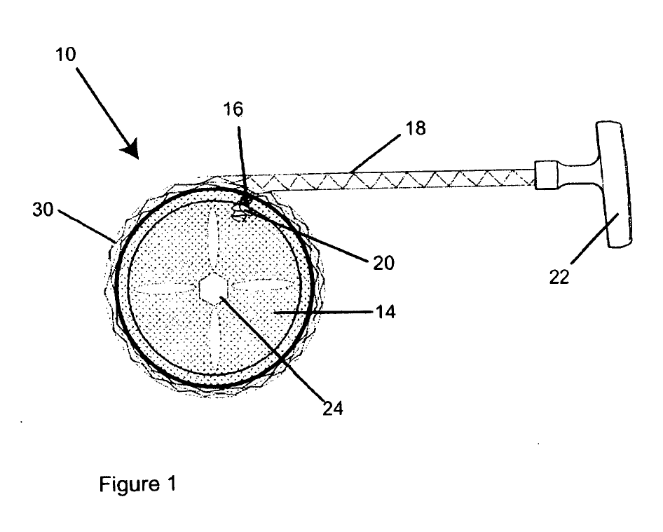

For a better understanding of the present invention and to show more clearly how it may be carried into effect, reference will now be made by way of example to the accompanying drawing in which FIG. 1 is a plan view of an embodiment of the present invention as it would be typically used in a pull starter assembly for an internal combustion engine.

### DETAILED DESCRIPTION

The present invention provides a starter pull cord for an internal combustion engine comprised of rope made from fibers of the class high-modulus. High-modulus fibers have much higher stiffness in tension than conventional fibers, and they are also significantly stronger than conventional fibers. This class includes the following fibers: liquid crystal polymer (LCP) (sold under the trademark VECTRAN), aramid (sold under the trademarks KEVLAR, TWARON, TECHNORA) and high-modulus polyethylene (HMPE) (sold under the trademarks SPECTRA, DYNEEMA).

The following table compares typical stiffness properties of nylon and the high modulus fibers.

| | Break Strength | Modulus, | Extension to Break |
|---|---|---|---|
| Fiber Type | grams/denier | grams/denier | Percent |
| Nylon | 705-10.5 | ~50 | 15-20% |
| LCP | 23-29 | 525-585 | 3.3-3.6% |
| Aramid | 18-28 | 432-1100 | 2.8-3.9% |
| HMPE | 25-40 | 790-1450 | 2.8-3.9% |

A particularly well suited rope for use in a preferred embodiment of a starter pull cord of the present invention is a single-braided rope of Vectran™ fibre and coated with a clear maxi-jacket coating of urethane to enhance abrasion resistance, distributed and sold under the trademark Vectrus™ by Yale Cordage of Saco, Me., USA. Advantageously, Vectrus™ rope also has the unique property of laying flat at a reduced thickness when it is wrapped around the starter pulley (as shown by reference number 30 in FIG. 1) which, due to the decreased cross-sectional width of the cord, allows more rotations around the starter pulley per foot of pull cord of the present invention than with conventional pull cords of the prior art that do not exhibit this flattening property. This translates to more revolutions of the engine per pull of the starter cord of the present invention, thereby increased starting inertia as well as less pulling travel to accomplish the starting in the engine.

The stiffness characteristic of nylon is very nonlinear, so only a general representative value is listed for modulus. Denier is a textile industry means of measuring the size of fiber, yarn and cord.

Referring to FIG. 1, a typical pull starter assembly 10 is illustrated as it would appear on a gasoline-powered engine. Typically, the pull starter assembly is contained within a starter housing (not shown). The pull starter assembly 10 has a starter reel or pulley 14 that has a pilot hole 16 through which one and of a starter pull cord 18 is threaded and then secured to the starter pulley with the application of a knot 20 that prevents the starter cord 18 from being withdrawn from the pilot hole 16. The other end, or free end of the starter pull cord 18 usually has a handle 22 for grasping by the user. The starter pulley 14 usually includes a groove (not shown) on its circumferential edge within which the starter pull cord 18 is located and wound around the starter pulley 14. The starter pulley 14 is connected to the engine crankshaft in some manner, exemplified by a bolt 24. Modern pull start systems employ a spring activated self-winding mechanism that disengages the starter pulley from the crankshaft and rotates the starter pulley to wind the starter pull cord 14 thereon when the pull cord is slackened, and which causes the starter pulley to engage the engine crankshaft when the pull cord is pulled rapidly thereby cranking over the engine to enable it to start.

In the effort to start the engine, a user might typically exert a pull of approximately 1 meter (3 ft) over an interval of 1 second. The impetus of this pull does not immediately transfer to the moving parts of engine. The mass of the engine's moving parts and the friction between these parts resists the impetus of the pull. Because prior art starter pull cords are not as stiff as those of the present invention, they stretch more and act as a spring or shock absorber, delaying and diminishing the impetus of the pull which is exerted on the engine. As a result, the engine shaft will not turn over as fast and the engine cylinder will not reciprocate as fast. In contrast, starter pull cords made of high modulus fibers stretch significantly less and impart more starting impetus to the engine.

The spark which ignites the air-fuel mixture in the engine cylinder is energized by electric power voltage generated by a magneto attached to the shaft. The magnitude of this voltage is a function of the speed of shaft revolution. If the engine shaft can be made to turn faster, more voltage is produced, and the likelihood of starting the engine is increased.

If the engine does not start on the first compression cycle, it still might start on a subsequent compression cycle. In the absence of fuel or a spark, the number of compression cycles which the engine goes through is a function of the rate of revolution and thus of the angular momentum achieved at the end of the starter pull. If the engine shaft can be made to turn faster, it will undergo more compression cycles and the likelihood of starting that the engine is increased.

The compression achieved in the engine cylinder is diminished by leakage around the cylinder. This leakage is minimal if the rate of compression is rapid. If the engine shaft can be made to turn faster, greater compression will be achieved and the likelihood of starting the engine is increased.

In embodiments of the present invention, starter pull cord 18 is comprised of rope made from high modulus fibers and exhibits a much higher stiffness in tension and than prior art pull cords. It is also significantly stronger and resistant to wear and breakage than the starter pull cords of the prior art. The higher stiffness of the starter pull cords of the present invention translates to greater impetus during the act of pull starting the engine, which is more apt to start on the first pull than with starter pull cords of the prior art.

In trials with power tool engines, experienced users have reported that it is easier to start engines equipped with high-modulus starter pull cords than the same engines equipped with conventional nylon starter pull cords. They report that it is not necessary to pull the cord as far or as hard to start the engine. They report that the engine is more apt to start on the first pull.

In laboratory tests, wet nylon and high-modulus fiber starter pull cords have been continuously cycled through the guide eyelet used on engine housings under the tension of a 10 lb (4.5 kg) weight. The nylon cords typically failed at 21,000 cycles or less. The high-modulus cords have survived at least 400,000 cycles without failure.

The pull cord 18 preferably comprises a multi-strand braided rope and may be single braided or double braided, or may be of another braid characteristic as is known in the art. The cross sectional diameter of the rope corresponds to the particular application as a pull cord: larger engines generally require a greater pull force and thicker pull cords. Typical dimensions for pull cords range from 3/32″ (2.4 mm) to ¼″ (6.4 mm) in diameter—the more common applications being from the middle of the range, namely ⅛″ (3.2 mm) to 3/16″ (4.8 mm)—but other thicknesses may be used as required.

In some embodiments, the starter pull cord is completely made of liquid crystal polymer fibers or other high-modulus fibers. Whereas in other embodiments, the starter pull cord may be partially made of high modulus fibers and partially of conventional yarns, provided that sufficient high-modulus fibers are present so that the rope exhibits significant improvements in stiffness and strength over the prior art starter pull cords.

In some embodiments of the present invention, the starter pull cord 18 is comprised of a rope made from 100% high-performance multifilament yarn that is melt spun from liquid crystal polymer, such as that sold under the trademark VECTRAN. VECTRAN fibers exhibit exceptional strength and stiffness. Yarn spun of VECTRAN fibers also exhibits high abrasion resistance, minimal moisture absorption, excellent chemical resistance, and high cut and impact resistance.

The high modulus fiber pull cords of the present invention also have the advantage that in a given application, the high modulus pull cords may be thinner than the prior art pull cords as a result of the increased strength characteristics of the high modulus fibers. This allows for a longer length of rope to be wound around a given starter pulley 14. The increased length of the pull cord means that it is less likely that a user will reach the end of the pull cord's travel while attempting to start an engine. Since reaching the end of the pull cord during a forceful pull imparts a significant shock on the pull cord, the starter assembly and the user's arm, shoulder and back, having a longer pull cord would reduce the possibility of damage to the pull cord or engine, and the possibility of injury to the user. In addition, a longer pull cord allows for a longer pull stroke, which imparts more rotations to the engine thereby potentially increasing the chance of it starting on a given pull stroke.

In another embodiment, the present invention comprises a kit for replacing a starter pull cord for an internal combustion engine comprising a rope made of high modulus fibers, a handle adapted to being connected to one end of said rope, and instructions that direct a user on how to effect the replacement of the starter pull cord.

The higher stiffness of the high modulus starter pull cords of the present invention translates to greater impetus during the act of pull starting and engine, which is more apt to start the engine on the first pull than the starter pull cords of the prior art. The increased strength of the high modulus starter pull cords translates to fewer breakages over the lifetime of an engine and therefore increased reliability and safety in applications where the user's well being is in some way related to his or her ability to start a manual-start engine.

Although the starter pull cord has been described in detail with reference to certain embodiments for purposes of illustration, other embodiments are possible. Therefore the spirit and scope of the appended claims should not be limited to the above description of the embodiments; the present inventions include suitable modifications as well as all permutations and combinations of the subject matter set forth herein.

I claim:

1. A starter pull cord for an internal combustion engine comprised of rope having high modulus fibers selected from the group consisting of liquid crystal polymer (LCP), aramid, and high-modulus polyethylene (HMPE).

2. The device as in claim 1 wherein the rope consists of high modulus fibers selected from the group consisting of liquid crystal polymer (LCP), aramid, and high-modulus polyethylene (HMPE).

3. The device as in claim 2 wherein the rope consists of liquid crystal polymer fibers.

4. The device as in claim 1 wherein the rope is a single braided, multi-strand rope braided from the high modulus fibers.

5. The device as in any one of claims 1 to 4 further including a handle connected to one end of said rope.

6. A method of starting an internal combustion engine that is adapted to being started by the act of pulling on a pull cord wrapped around a pulley, the method comprising the steps of:
wrapping a rope comprising high modulus fibers selected from the group consisting of liquid crystal polymer (LCP), aramid, and high-modulus polyethylene (HMPE) around the pulley, leaving a free end of the rope; and
pulling on the free end rapidly to impart rotation to the pulley.

7. The method as in claim 6 further comprising the step of attaching a handle to the free end of the rope and pulling on the handle.

8. The use of a rope comprising high modulus fibers selected from the group consisting of liquid crystal polymer (LCP), aramid, and high-modulus polyethylene (HMPE) as a starter pull cord for an internal combustion engine.

9. The use as in claim 8 wherein the rope consists of high modulus fibers selected from the group consisting of liquid crystal polymer (LCP), aramid, and high-modulus polyethylene (HMPE).

10. The use as in claim 9 wherein the rope consists of liquid crystal polymer fibers.

11. The use as in any one of claims 7 to 10 wherein the rope is a single braided, multi-strand rope braided from the high modulus fibers.

12. A kit for replacing a starter pull cord for an internal combustion engine comprising: a rope having high modulus fibers selected from the group consisting of liquid crystal polymer (LCP), aramid, and high-modulus polyethylene (HMPE);
a handle adapted to being connected to one end of said rope; and instructions that direct a user on how to effect the replacement of the starter pull cord.

13. The kit as in claim 12 wherein the rope consists of high modulus fibers selected from the group consisting of liquid crystal polymer (LCP), aramid, and high-modulus polyethylene (HMPE).

14. The kit as in claim 13 wherein the rope consists of liquid crystal polymer fibers.

15. The kit as in claim 14 wherein the rope is a single braided, multi-strand rope braided from the high modulus fibers.
